(19) United States
(12) Patent Application Publication
(10) Pub. No.: US 2009/0142002 A1
(43) Pub. Date: Jun. 4, 2009

(54) POLYGON AND POLYLINE MEASURING TOOL FOR GIS APPLICATIONS

(75) Inventor: John Middendorf, Pagosa Springs, CO (US)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: LYNX GEOSYSTEMS, LLC A Colorado Limited Liability Company

(21) Appl. No.: 12/237,375

(22) Filed: Sep. 24, 2008

Related U.S. Application Data
(60) Provisional application No. 60/974,950, filed on Sep. 25, 2007.
(60) Provisional application No. 60/975,508, filed on Sep. 26, 2007.
(60) Provisional application No. 61/013,395, filed on Dec. 13, 2007.

(51) Int. Cl. G06K 9/36

(52) U.S. Cl. 382/286

(57) ABSTRACT

Methods and systems for aggregating points into segments to facilitate measurements relating to GIS polylines and/or polygons are provided. According to one embodiment, a request for information is received regarding a shape representing a geographic feature displayed within a geographic information system (GIS) application. One or more measurement segments are programmatically identified by selecting multiple measurement vertices from a set of points associated with the shape based on one or more predetermined selection criteria. The remaining intervening points of the set of points not selected as measurement vertices define sub-segments of the measurement segments. A length of each of the measurement segments is then calculated and displayed by summing corresponding sub-segments.

### CROSS-REFERENCE TO RELATED APPLICATIONS

This application claims the benefit of priority to U.S. Provisional Patent Application No. 60/974,950, filed on Sep. 25, 2007; U.S. Provisional Patent Application No. 60/975,508, filed on Sep. 26, 2007; and U.S. Provisional Patent Application No. 61/013,395, filed on Dec. 13, 2007, each of which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2007-2008, Lynx Geosystems, LLC.

### BACKGROUND

1. Field

Embodiments of the present invention generally relate to mapping and Geographic Information Systems (GIS). More specifically, embodiments of the present invention facilitate a measuring tool for GIS polylines and polygons and an automated method of converting a set of points to a set of lines and/or polylines based on a unique vertex analysis process.

2. Description of the Related Art

There are dozens, perhaps hundreds, of GIS data formats, an example of which is the ERSI™ “Shapefile” format, a technical description of which can currently be obtained from the World Wide Web at http://www.esri.com/library/whitepapers/pdfs/shapefile.pdf, which is hereby incorporated by reference in its entirety for all purposes. The ERSI shapefile format is a data standard representing features as either points, lines, or polygons. A shapefile can only contain one of these types. For example, a shapefile cannot contain both point and line features; therefore, each shapefile type is noted as a point, polyline, or polygon shapefile. Polylines and polygons may include apparent curved segments; however, the native shapefile format does not recognize or group parts of a feature into lines or segments, but rather represents all polylines and/or polygons as a series of connected points. Another example of an existing GIS data format is the MapInfo Interchange Format (.mif). This format allows for storage of points, polylines, and/or polygons all within the same data file. Polygons stored within the MapInfo Interchange Format (.mif) are call “regions.” Yet another example of an existing GIS data format is the Keyhole Markup Language (.kml) format and conventions. This format stores data for each distinctive point, polyline, and/or polygon as a distinctive data segment. This format and convention uses an XML type format. As presently understood by the inventor, no current GIS data format stores polygons as a network of lines or segments, which would be helpful in the context of certain applications, such as measuring tools.

State-of-the-art GIS software applications include measuring tools that allow the user to select a geographic feature's internal points in order to manually measure the distance between points, such as endpoints of a user-defined line or segment. Using existing measuring tools, accurately measuring the length of curved or irregularly shaped portions of geographic features or the perimeter of geographic features can be a tedious and time consuming process for geographic features that are represented by a large number of internal points. For example, a curved segment may be represented by a large number of closely placed points in the form of a polyline or portion of a polygon. A user wishing to extract measurement information related to physical features using existing GIS software applications must manually select measurement vertex points, manually extract distances between the selected vertex points, and manually sum up the extracted distances, and/or manually mathematically manipulate the manually extracted data to calculate areas and/or make better estimates of the physical features of interest. This tedious and time consuming process, in addition to being labor intensive and aggravating, can at times also be error prone and lack accuracy.

Thus, there is a need in the art for more intelligent measurement tools as well as the underlying mechanisms, such as vertex analysis processes, to facilitate creation of same.

### SUMMARY

Methods and systems are described for aggregating points into segments to facilitate measurements relating to GIS polylines and polygons. Various embodiments of the present invention include methods and systems for receiving requests for information regarding distinguishable shapes represented and displayed by a GIS application. Shapes represent geographic features. Embodiments of the present invention also include programmatically identifying one or more measurement segments by selecting a plurality of measurement vertices from the set of points associated with each shape based on one or more predetermined selection criteria. Any remaining intervening points of the set of points, and not selected as measurement vertices, define one or more sub-segments of one or more measurement segments. Such methods further include calculating a length of each of the one or more measurement segments by summing corresponding sub-segments, and then displaying one or more calculated lengths for one or more measurement segments.

Often, for the aforementioned embodiment of the present invention, the shape corresponds to a real estate parcel boundary, and for some cases, the calculated length represents a portion of the perimeter of the parcel boundary. Also, in some other instances, the portion of the perimeter that is calculated and displayed includes the entire parcel boundary in its entirety.

In other instances of the aforementioned embodiments, the methods and systems further comprise receiving an indication regarding a point of the set of points to be used as a starting measurement vertex.

In yet further instances, the systems and methods further comprise receiving an indication regarding a point of the set of points to be excluded from the plurality of measurement vertices.

In some other instances, the systems and methods further comprise receiving an indication regarding a point of the set of points to be included within the plurality of measurement vertices.

In some instances of the aforementioned embodiments, the request comprises an end user selection of a sub-segment of the shape such that the identifying, calculating and displaying is performed only for a measurement segment including the selected sub-segment.

In still other instances of the aforementioned embodiments, the systems and methods further comprise reading the set of points from a vector data file, and in some cases, the vector data file comprises a shapefile. In addition, and for some instances of the aforementioned embodiments, the shapefile format used within the GIS application is defined by the ERSI™ shapefile format.

Some instances of the aforementioned embodiments of the present invention utilize methods including: determining a first distance between a first point and a second point of the set of points; and determining a second distance between the second point and a third point of the set of points. These embodiments further include calculating an angle formed by a first sub-segment bounded by the first point and the second point and a second sub-segment bounded by the second point and the third point. Also, selecting the second point as one of the plurality of measurement vertices is done if the angle meets a predefined angle threshold and the first distance meets a predefined distance threshold.

Still other embodiments of the present invention utilize methods including retrieving a set of points from a geospatial vector data file with each adjacent pair of points of the set of points representing a segment of a multi-segment, two-dimensional shape. These embodiments also include programmatically determining one or more characteristics associated with a plurality of segments of the multi-segment, two-dimensional shape, and programmatically aggregating the plurality of segments into a measurement segment by identifying two points of the set of points to be used as measurement vertices based on the one or more characteristics. In addition, these embodiments further include calculating and displaying a length of the measurement segment by summing lengths associated with each of the plurality of segments.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating an example of a computer system in which embodiments of the present invention may be utilized.

FIG. 2 is a block diagram conceptually illustrating a simplified computer network architecture in which embodiments of the present invention may be employed.

FIG. 3 illustrates a parcel with three measurement vertices in accordance with an embodiment of the present invention.

FIG. 4 is an additional illustration of the parcel of FIG. 3 in which all points (or vertices) are depicted in accordance with an embodiment of the present invention.

FIG. 5 illustrates another parcel with five measurement vertices programmatically identified in accordance with an embodiment of the present invention.

FIG. 6 is an additional illustration the parcel of FIG. 5 in which all points are depicted for the polygon at issue in accordance with an embodiment of the present invention.

FIG. 7 illustrates the same parcel as FIG. 5 and FIG. 6 with six measurement vertices programmatically identified, the parcel area calculated, and each of the line segments between the measurement vertices measured and displayed in accordance with an embodiment of the present invention.

FIG. 8 is a block diagram conceptually illustrating three points (or vertices), in either a 2-dimensional or a 3-dimensional coordinate system.

FIG. 9 is a flow diagram illustrating a method in accordance with an embodiment of the present invention.

FIG. 10 is a flow diagram illustrating another method in accordance with an embodiment of the present invention.

FIG. 11 is a flow diagram illustrating another method in accordance with an embodiment of the present invention.

FIG. 12 is a flow diagram illustrating yet another method in accordance with an embodiment of the present invention.

### DETAILED DESCRIPTION

### Terminology

Brief definitions of terms used throughout this application are given below.

The term “acute angle” refers to an angle in planar geometry of less than 90 degrees (or less than π/2 radians).

The phrase “acute or obtuse angle,” refers to an angle in planar geometry of less than 180 degrees (or less than π radians).

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as an email client.

The terms “connected” or “coupled” and related terms are used in an operational sense and are not necessarily limited to a direct connection or coupling.

The phrase “geographic feature” generally refers to a shape within a GIS data base or data structure that has a defined boundary or periphery. For example, geographic features may include transportation infrastructure, such as streets and highways, trade areas, boundaries, such as ZIP Code boundaries, parcel boundaries, park boundaries, city boundaries, county boundaries, state boundaries and political boundaries rivers, lakes, park boundaries, buildings, city boundaries, land uses, buildings, structures, and the like.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The phrase “measurement segment” generally refers to one or more contiguous line segments bounded by a pair of measurement vertices. In various embodiments of the present invention, an aggregate length or distance measurement is calculated for a measurement segment by summing the lengths of one or more contiguous segments that make up the measurement segment.

The phrase “measurement vertex” generally refers to a point that has been selected from a set of vertices and from which a length or distance measurement will be made. In various embodiments of the present invention, a set of ordered points, representing a geographic feature, may be read from a database associated with a geographic information system (GIS) application. The number of ordered points may number in the tens or hundreds depending upon the context, shape, size and/or type of geographic feature at issue. In accordance with an embodiment of the present invention, for purposes of facilitating the communication of geographic feature measurements to an end user, the set of ordered points representing the geographic feature may be evaluated to identify a series of vertices to be aggregated together as a measurement segment bounded by a pair of measurement vertices.

The term “obtuse angle” refers to an angle in planar geometry of between 90 degrees and 180 degrees (or greater than π/2 radians and less than π radians).

The term “reflex angle” refers to an angle in planar geometry of between 180 degrees and 360 degrees (or greater than π radians and less than 2π radians).

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible. The term “server” also encompasses software that makes the act of serving information or providing services possible.

The phrases “vector data file,” “vector data format,” “spatial data file,” “spatial data format” and the like are intended to broadly encompass current and future GIS data formats and GIS data types that store polylines and/or polygons as a series of points (as opposed to a mathematical representation of a segment, such as a Bezier curve).

The term “vertex” generally refers to a common point of two segments. In the context of various embodiments of the present invention, a polygon or polyline may be defined by a listing of points. Each pair of points in the list defines a sub-segment and one or more sub-segments may be aggregated to define a segment. The endpoints of each of these segments are considered vertices of the polygon or polyline at issue.

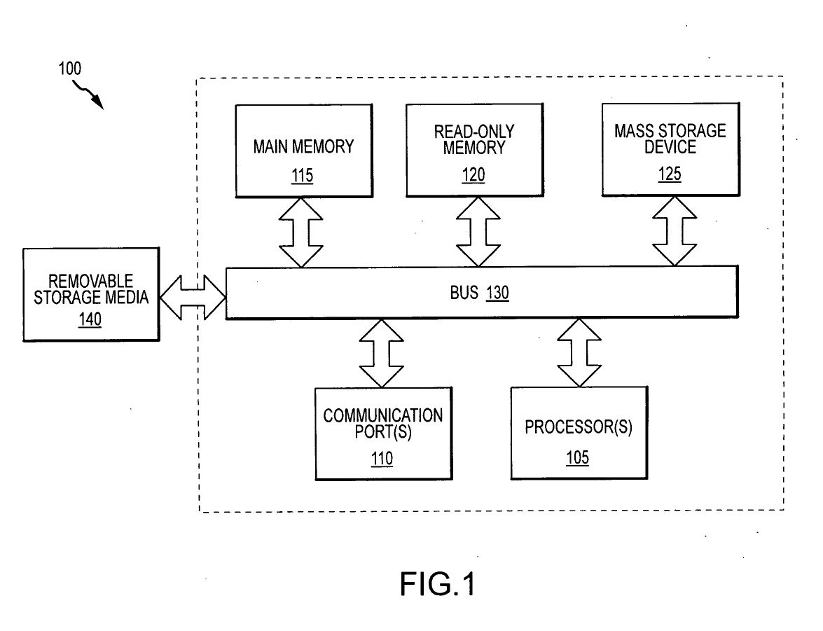

Embodiments of the present invention include various steps, which will be described in more detail below. A variety of these steps may be performed by hardware components or may be embodied in machine-executable instructions, which may be used to cause a general-purpose or special-purpose processor programmed with instructions to perform these steps. Alternatively, the steps may be performed by a combination of hardware, software, and/or firmware. As such, FIG. 1 is an example of a computer system 100, such as a workstation, personal computer, laptop, client or server, upon which or with which embodiments of the present invention may be employed.

According to the present example, the computer system includes a bus 130, at least one processor 105, at least one communication port 110, a main memory 115, a removable storage media 140, a read only memory 120, and a mass storage 125.

Processor(s) 105 can be any known processor, such as, but not limited to, an Intel® Itanium® or Itanium 2 processor(s), or AMD® Opteron® or Athlon MP® processor(s), or Motorola® lines of processors. Communication port(s) 110 can be any of an RS-232 port for use with a modem based dialup connection, a 10/100 Ethernet port, or a Gigabit port using copper or fiber. Communication port(s) 110 may be chosen depending on a network such a Local Area Network (LAN), Wide Area Network (WAN), or any network to which the computer system 100 connects.

Main memory 115 can be Random Access Memory (RAM), or any other dynamic storage device(s) commonly known in the art. Read only memory 120 can be any static storage device(s) such as Programmable Read Only Memory (PROM) chips for storing static information such as start-up or BIOS instructions for processor 105.

Mass storage 125 can be used to store information and instructions. For example, hard disks such as the Adaptec® family of SCSI drives, an optical disc, an array of disks such as RAID, such as the Adaptec family of RAID drives, or any other mass storage devices may be used.

Bus 130 communicatively couples processor(s) 105 with the other memory, storage and communication blocks. Bus 130 can be a PCI/PCI-X or SCSI based system bus depending on the storage devices used.

Optionally, operator and administrative interfaces, such as a display, keyboard, and a cursor control device, may also be coupled to bus 130 to support direct operator interaction with computer system 100. Other operator and administrative interfaces can be provided through network connections connected through communication ports 110.

Removable storage media 140 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

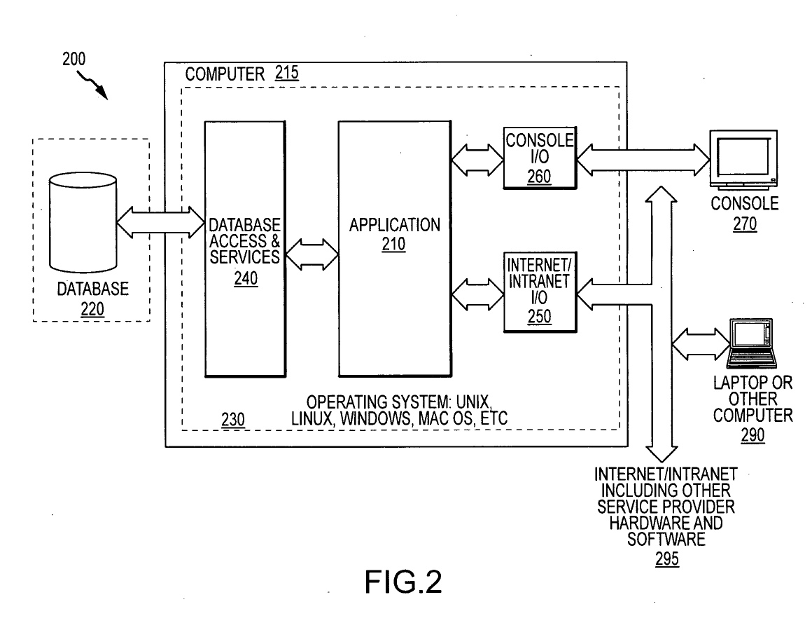

Components described above, and also in the context of FIG. 2, are meant to exemplify some types of possibilities. In no way should the aforementioned examples limit the scope of the invention, as they are only exemplary embodiments.

FIG. 2 is a block diagram that illustrates a typical multi-user and multi-computer system architecture 200 that may be used in many database applications and in connection with one or more embodiments of the present invention. In the present example, the architecture 200 includes a database 220, a computer 215, a console 270, and at least one other laptop or other computer 290 connected and linked to computer 215 via the Internet (or Intranet) 295.

Computer 215 runs an operating system 230, such as UNIX, Linux, Windows, etc. An application 210, such as an application that defines steps and performs tasks according to various embodiments of the present invention, then runs within the operating system 230 environment. The operating system 230 supports a set of database access and services 240, such as a Java Database Connectivity (JDBC) API, an Open DataBase Connectivity (ODBC) database API, etc., The database access and services 240, allows an application 210 to create, access, and manipulate data within the database 220 and otherwise interact with the database 220. A console input/output (I/O) interface 260 facilitates interactions between an application 210 and a console 270. An Internet/intranet I/O interface 250 is coupled to the Internet (or an Intranet) 295 to connect a laptop or other computer 290 for communication with computer 215, and thus allows for use of application 210 and database 220 by the external laptop or other computer 290.

As explained above, the application 210 runs with the operating system 230, which in turn runs on the computer 215. In addition, users may interact with the application 210 using a console terminal 270, via console input/output (I/O) 260, connected directly to the computer 215. In other cases, users gain access to the application 210 through another device (such as a laptop or other computer) connected to a network such as the Internet, a local intranet, or both. Embodiments of the present invention are therefore encoded as machine steps and operations that exist and are coded as part of application 210. As a user utilizes application 210, the database 220 is also used to query information and to extract the portions of the database 220 of interest to the user.

Single stand alone computers as well as various networked computers architectures are conceivable when practicing various embodiments of the present invention. FIG. 1 and FIG. 2 are for illustrative purposes only, and in no way may be considered to limit any existing or potential future programmable machine configurations for physical implementations of various embodiments of the present invention. FIG. 2 also does not intend to limit any conceivable stand alone nor does it limit any networked computer configurations for utilizing various different embodiments of the present invention. In a single computer stand alone configuration, the Internet/Intranet 295, Internet/Intranet I/O 250, and laptop or other computer 290 are not present, or at least are not needed nor used, when computer 215 and the user via the console 270 are practicing embodiments of the present invention. For these types of implementations, application 210 and database 220 may have been loaded earlier on computer 215 from a diskette, CD ROM, DVD, or other removable and portable media storage device. Also, it may be possible for a user to be using a single stand alone computer 215 when practicing embodiments of the present invention, but at an earlier time had this single computer connected to the Internet, or other Intranet servers, and at this earlier time then did have an application 210 and database 220 (or portion of the database 220 of interest) downloaded prior to using the methods and machine algorithms incorporating embodiments of the present invention.

In addition to stand alone single computer configurations and the wide range of multiple computer configurations illustrated in the context of FIG. 2 and elsewhere, one more additional example, and just for illustrative purposes, and this is again just one small case from the very wide universe of possible computer architecture configurations for practicing embodiments of the present invention, but it is also worth mentioning configurations wherein a larger and more complete primary database 220 exists on a separate computer than the computer 215 wherein the application 210 is loaded. In such an example, a user using a laptop or other computer 290 connects to computer 215 through the Internet (or a local intranet) 295 wherein application 210 is to be executed. Henceforth, as application 210 requires portions of database 220, computer 215 then goes to yet a third computer via the Internet (or a local intranet) 295 to download and access the needed portions of database 220, and the database 220 is more permanently maintained and stored on this third computer. Computer 215 can temporally store and use the required portions of database 220. For example, a user using a laptop or other computer 290 could go via the Internet 295 to a software application supplier's computer 215 via, for example, a web page loaded with an interface for providing access to application 210. As application 210 is executed on computer 215 for an external user, the external user now using computer 215 could then go to yet other web page, and thus be using yet another external computer system for acquiring database 220. Various Boards of Realtors, Federal, state, and county governments are examples of other entities offering access to databases for downloading cadastral, MLS, topographic, address, mapping, and other geographic data of interest that may be useful for performing steps of an application 210 according to various embodiments of the present invention.

Different embodiments of the present invention are discussed in the context of GIS mapping, GIS data conversion, measurement, and calculation applications. However, embodiments of the present are also applicable to other functions and algorithms performed on topographic, cadastral, MLS, address, and other geographic data. Similarly, although embodiments of the present invention may be described in the context of a client application, the functionality described herein may be fully or partially implemented within a server and accessed through a browser-based interface. Also, for example, embodiments of the present invention exist within interactive point and click application tools, and in the alternative, may also exist within batch mode executable tools as well.

The following descriptions set forth numerous specific details in order to provide a thorough understanding of various embodiments of the present invention. It is however apparent, to one skilled in the art, that other embodiments of the present invention may be practiced without some of these set forth specific details. Also, and in other instances, various different and additional well-known other structures, flows, process steps, and/or devices, in addition to those shown in block and flow diagram form and described herein, may also be utilized for replacement and/or in addition to those shown and still be practicing within the spirit of the present invention.

Embodiments of the present invention include various steps, which will be described below. These steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware, and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While for sake of illustration, various embodiments of the present invention are described herein in the context of a mapping and information tool for real estate professionals (i.e., agents of buyers and sellers), embodiments of the present invention are equally applicable to software applications and systems used directly by prospective buyers and sellers of real estate. As such, the illustrated applications of the embodiments of the present invention are not meant to be limiting, but instead exemplary.

While for sake of illustration, different embodiments of the present invention are described with respect to GIS mapping, GIS data conversion, measurement, and calculation applications, and it is to be understood that embodiments of the present invention have broader applicability more generally. For example, various aspects and features of embodiments of the present invention may be used in connection with other forms of mapping, data conversion, measurement, and calculation applications, including, but not limited to, GIS mapping, GIS data conversion, measurement, and calculation applications and/or the like.

Embodiments of the present invention are able to extract measurements and/or other physical dimensions of interest including and not limited to lengths, perimeters, and areas interactively from GIS data sets. In some instances, portions of GIS data sets are reduced to a plurality of points, also referred to a plurality or a set of, “vertices.” Some physical features, including and not limited to boundaries within GIS data sets, are represented as a set of vertices. In addition to each point or vertex of a set of vertices representing a location in linear, two dimensional, and/or three dimensional spaces, other parameters or attributes can also be stored and associated with each point or vertex. A road for example can be represented in a GIS data set as a set of center points (or vertices) and another parameter stored with each vertex representing the width of the road at each point. However in contrast, and for many alternate embodiments, GIS data sets represent a road simply as a set of vertices, with each vertex representing a point on the perimeter of the road outline. Various methods of the present invention operate on sets of vertices to extract measurements and/or other information desirable to an end user. For some cases, identifying or extracting accurate distances, lengths, perimeters, and/or areas are the measurements and information of interest.

Embodiments of the present invention operate on one or more of a variety of different GIS data formats, which are at times generally referred to herein as spatial data files or vector data files. Depending upon the implementation needs, different methods for representing points, sets of points, lines, segments, arcs, curves, circles, polygons, and other shaped areas in GIS data structures may be accommodated by embodiments of the present invention. For example, in one embodiment, a vertex analysis process (described in further detail below) may be used to convert GIS data stored in a vector data file as a set of connected points into a set of lines or segments. Alternatively, GIS data stored as sets of lines or segments may be broken down into sets of vertices within various embodiments of the present invention. Also, for three dimensional GIS data structures, in addition, physical features including surfaces and volumes represented in GIS data can be rendered down to sets of vertices. In some embodiments of the present invention, source GIS data is in a GIS data format corresponding to the ERSI “shapefile” technical specification and description.

Various different shape types in ERSI shapefile format, and/or for other GIS data structures, are described as none, one vertex, or more than one vertex. Some embodiments of the present invention, but not limited to, can operate directly on ERSI shapefile GIS data formats wherein different physical features are each represented as a plurality of one or more vertices. For example, and not limited to, some embodiments of the present invention have methods for interactively, or in batch mode, identifying and measuring a distance between two distinct physical features within a GIS data structure, and wherein each of the two distinctive physical features are each represented as a single point or vertex. In alternate embodiments, or in a single embodiment having multiple methods, other methods and capabilities for measuring distances along a single physical feature comprising two or more vertices are also contemplated and encompassed by embodiments of the present invention.

Also, and not limited to, and in some other examples, embodiments of the present invention operate on GIS data structures represented by the MapInfo Interchange Format (.mif). This format allows for storage of points, polylines, and/or polygons all within the same data file. Polygons stored within the MapInfo Interchange Format (.mif) are call “regions.”

Also, and not limited to, and in some other examples, embodiments of the present invention operate on GIS data structures represented by the Keyhole Markup Language (.kml) format and conventions. This format stores data for each distinctive point, polyline, and/or polygon as a distinctive data segment. This format and convention uses an XML type format. Furthermore, another compressed Keyhole Markup Language format version can also be used by embodiments of the present invention, and this version generally refers to GIS data files using the file extensions of (.kmz).

Within the spirit of the present invention, the details of the data format used by a GIS application is not a limitation, and for the above mentioned data formats that are used by various embodiments of the present invention, these data format are only examples, and are for explanatory purposes only, and these mentioned data format types do not limit the scope of the present invention. It will be obvious to one skilled in the art, that there are literally hundreds of data formats for GIS data structures, and one skilled in the art will see how the various different embodiments of the current invention can each be applied to any selected GIS data format.

For the above mentioned GIS data structures formats, a single or a sum of points are used as the rudimentary methods for illustrating physical features within the GIS data structure. Furthermore, additional and different GIS data structure types utilizing a single or sum of networked lines can also be operated on by various embodiments of the present invention. Lines and polygons can always be rendered down to sets of points, and then these sets of points can themselves have measurement vertex analysis in accordance to various embodiments of the present invention, as is described further below.

In the following figures both flow diagrams and block diagrams are discussed together as illustrative examples of some embodiments of the present invention. It should be noted that while flow diagrams are discussed in relation to elements of particular block diagrams, similar methods may be applied to various other and different embodiments. Furthermore, some embodiments of the present invention have methods that do not require as many of the blocks illustrated in the following examples as defined by the claims and also described elsewhere herein.

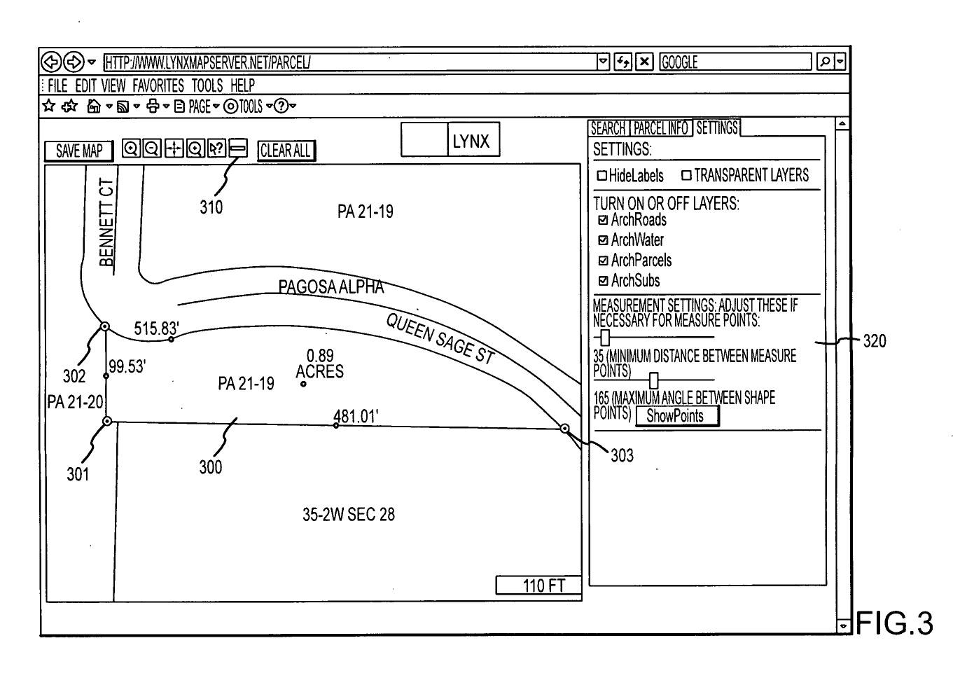

Turning to FIG. 3, a parcel 300 is illustrated with three measurement vertices. In addition, parcel 300 has also been measured in accordance with an embodiment of the present invention. According to the present example, a user of a GIS application has selected a parcel 300 designated as PA 21-19 for measurement. Responsive to the user selection coupled with prior activation of a “ruler” icon 310 in the tool bar, the measurement algorithm, has programmatically identified three measurement vertices 301, 302 and 303 based on polygon information associated with parcel 300.

Furthermore and additionally, measurement vertices selection criteria (or possibly one criterion) often are used according to various different schemes and algorithms in order to determine all measurement vertices. In some embodiments, measurement vertices selection criteria involve specification, by the user or an administrator, for example, of associated predetermined threshold limit values prior to running a tool (or application) for determining all measurement vertices. Notice the “Measurement Settings” area 320, which illustrates that two measurement criteria have been used within this embodiment and for this example. Measurement vertices selection criteria are described in more detail below.

According to the present example, after identifying the measurement vertices 301, 302 and 303, the measurement tool (application) calculated length measurements for each of the segments (i.e., segment 301-302, segment 302-303 and segment 303-301) between the measurement vertices for the polygon defining the selected parcel and then displayed the measurements along each corresponding segment. In the present example, as displayed in FIG. 3, the segment defined by measurement vertices 301 and 302 was determined to be 99.53 feet, the segment defined by measurement vertices 302 and 303 was determined to be 515.83 feet and the segment defined by measurement vertices 303 and 301 was determined to be 481.01 feet. According to the present example, the measurement tool also calculates and displays the acreage of the parcel. Parcel 300 was determined to be 0.89 acres.

The measuring system may perform a series of qualifiers for each point of a polyline or polygon feature to determine programmatically whether that particular point should be identified as a measurement vertex point. As mentioned above, various different measurement vertices selection criteria, algorithms, and schemes are used by various different embodiments of the present invention. A detailed example of just one embodiment's measurement vertices selection criteria is contained within the code section of the attached Appendix 1.

For example, in some embodiments, an angle formed between a particular point and imaginary lines created by the previous and next point in the GIS data source, e.g., a vector data file, are tested. Further, the distance between a particular point, the previous point, and the next point may be tested. Using this data, a determination can be made based on configurable or predetermined minimum distance and maximum angle settings (which can also be determined programmatically based on aggregate values of angles and distances between all the points in the GIS data source) as to whether or not to include each particular point as a displayed measurement vertex point.

Notice again in FIG. 3, a measurement settings area 320 allows the user to adjust either or both a minimum distance between measurement vertex points and a maximum angle between points. According to the settings depicted in the present example, measurement vertices are desired to be at least 35 feet apart and the angle formed by the previous and next points is desired to be less than or equal to 165 degrees to allow a particular point to be identified as a measurement vertex.

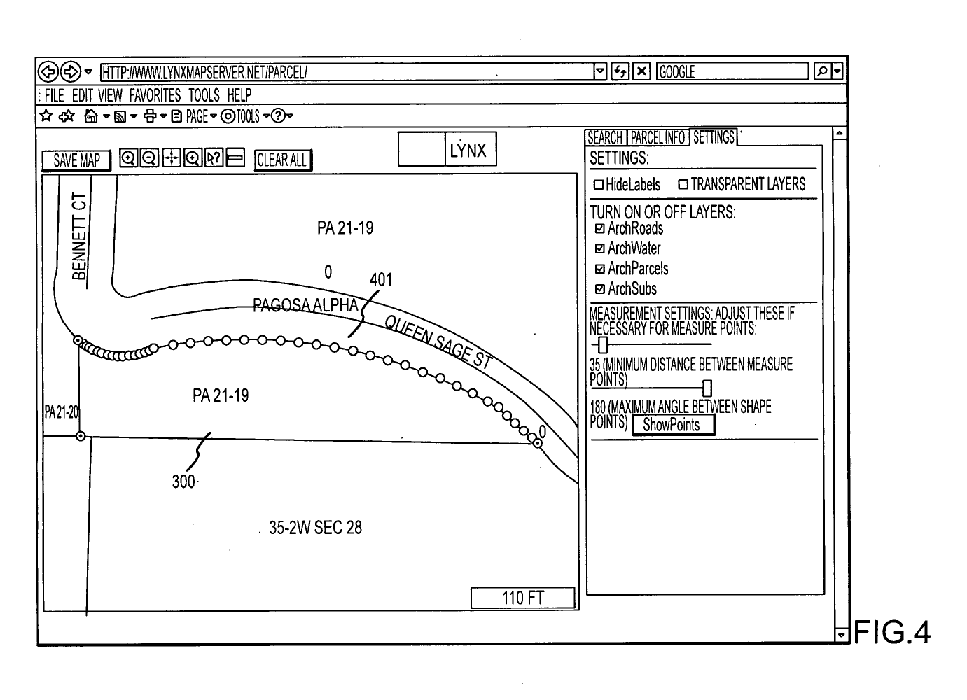

FIG. 4 illustrates parcel 300 of FIG. 3, but now with all points depicted for the polygon at issue in accordance with an embodiment of the present invention. As can now be appreciated, segment 401 is comprised of more than 50 points, and wherein the distances between which have been in FIG. 3 automatically determined and aggregated for the user in accordance with an embodiment of the present invention.

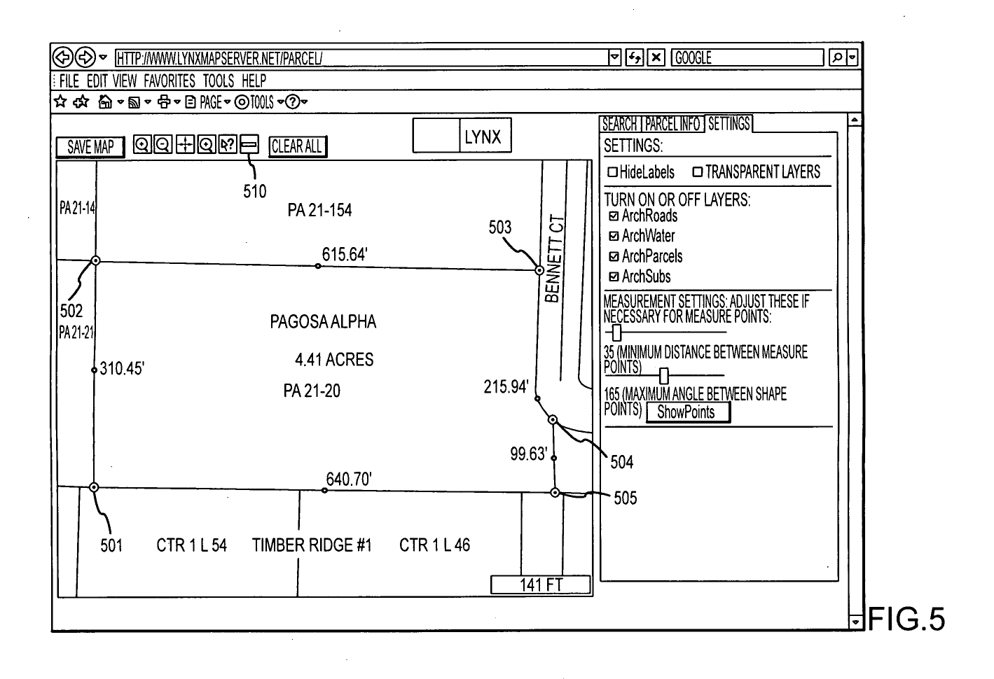

FIG. 5 illustrates another parcel 500 that has been measured in accordance with an embodiment of the present invention. According to the present example, the user has selected a parcel 500 designated as PA 26-20 for measurement. Responsive to the user selection coupled with prior activation of the “ruler” icon 510 in the tool bar, the measurement algorithm, has programmatically identified five measurement vertices 501, 502, 503, 504 and 505 based on polygon information associated with parcel 500.

According to the present example, after identifying the measurement vertices 501, 502, 503, 504 and 505, the measurement tool calculated the measurements for each of the segments (i.e., segment 501-502, segment 502-503, segment 503-504, segment 504-505 and segment 505-501) of the polygon defining the selected parcel, and displayed the measurements along each corresponding segment. In the present example, the segment defined by measurement vertices 501 and 502 was determined to be 310.05 feet, the segment defined by measurement vertices 502 and 503 was determined to be 615.64 feet, the segment defined by measurement vertices 503 and 504 was determined to be 215.94 feet, the segment defined by measurement vertices 504 and 505 was determined to be 99.53 feet and the segment defined by measurement vertices 505 and 501 was determined to be 640.70 feet. According to the present example, the measurement tool also calculates and displays the acreage of the parcel 500. Parcel 300 was determined to be 4.41 acres.

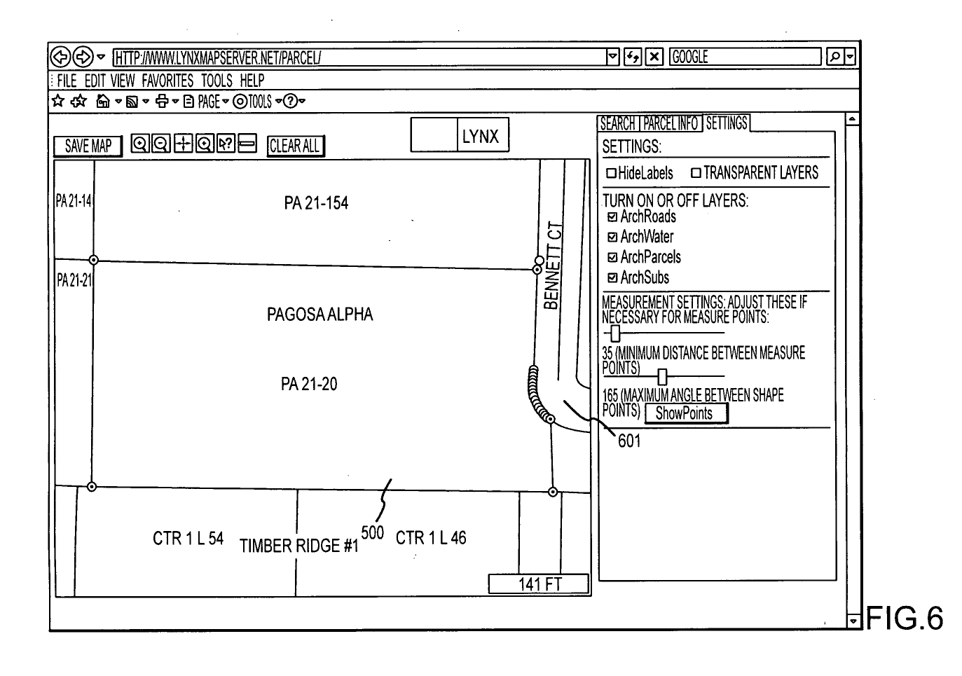

FIG. 6 illustrates parcel 500 of FIG. 5, but with all points depicted for the polygon at issue in accordance with an embodiment of the present invention. As can now be appreciated, the curved portion 601 of segment 504-505 is comprised of over ten points, the distances between which by embodiments of the present invention have been automatically and programmatically determined and aggregated.

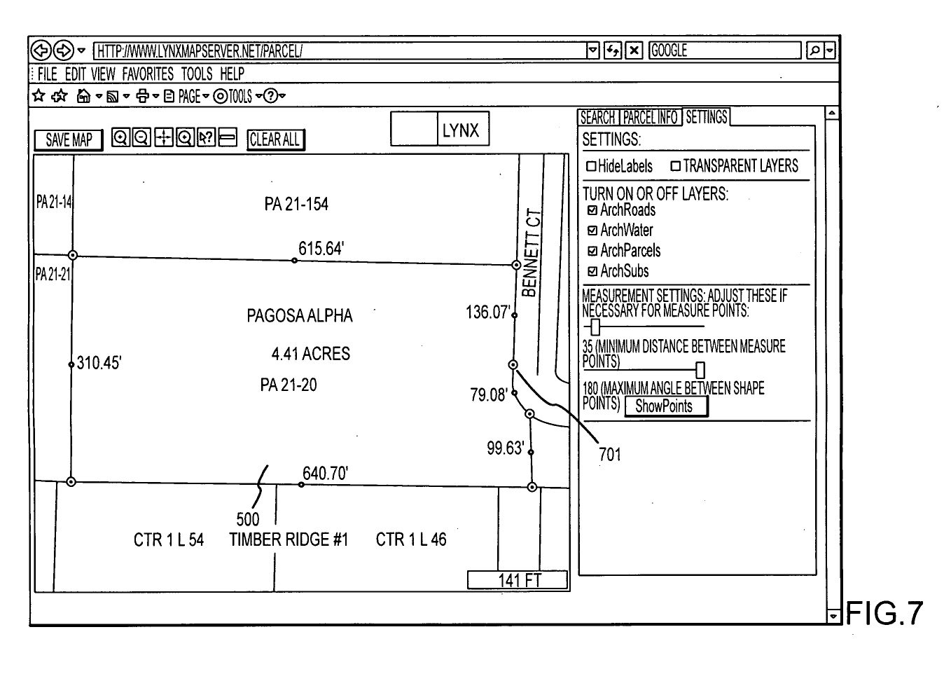

FIG. 7 illustrates parcel 500 of FIG. 5, but without limiting the angle criterion to 165 degrees in accordance with an embodiment of the present invention. Thus, in the present example, an additional measurement vertex, measurement vertex 701, (previously excluded by the 165 degree angle limitation of FIG. 5) has been programmatically identified and depicted. Also, further additional measurement vertices within FIG. 7 have not been programmatically identified by this one embodiment of the present invention because, although more segments are not collinear, no more additional measurement vertices can be programmatically identified while still guaranteeing that all the nonlinear segments continue to meet the minimum distance requirement. Measurement vertex 701 divided a former measurement line segment of FIG. 5 of length 215.94 feet into two measurement segments now shown as 136.87 feet and 79.08 feet each respectively in FIG. 7. The fact that the summation of the two newly formed measurement segment exceeds the former measurement segment by 0.01 feet is to be expected at times, and is not surprising, if one gives consideration for rounding of lower significant figures of accuracy. Furthermore, if an algorithm merely dropped (or truncated) lower significant figures of accuracy, then the summation of the two newly formed measurement segments would be expected to be equivalent to the original segment length, or possibly 0.01 feet less than the original segment. Various embodiments of the present invention use rounding of the lower significant figures of accuracy, while other embodiments use truncation.

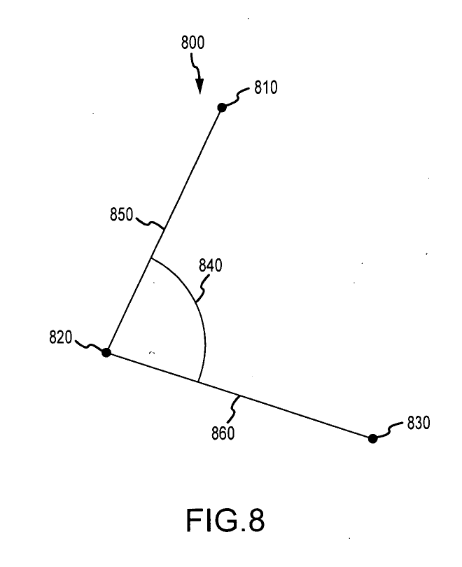

Turning to FIG. 8, a block diagram 800 depicts three points or vertices in space 810, 820, and 830. Vertex 810, vertex 820, and vertex 830 can be defined using one of many schemes for representing two dimensional or three dimensional coordinate systems. An acute or obtuse non-180 degree angle, called, “θ,” 840 will exist as a relationship between line segments 850 and 860 at any time that vertex 810, vertex 820, and vertex 830 are not collinear. Illustrated by block diagram 800, the angle θ 840 is created by intersecting line segments 850 and 860, and is said to have a “vertex” at point 820. Thus, points are called vertices interchangeably within context of the present disclosure. Some methods of the present invention compare the angle θ 840 against a predetermined threshold at every point in the GIS data set at issue to determine if the point should be marked as a “measurement vertex”, thus every point may be considered as a possible measurement vertex.

As an example and not limited to, when embodiments of the present invention operate on a “polygon” shape type described by the ERSI shapefile format, then the last point in the GIS data set is equivalent to the first, and thus a “closed loop” or “closed perimeter” is defined. Conceptually for a GIS closed loop data set or perimeter, the data points wrap around such that every point has two neighbors, and an order to the list of points is presumed with each point having a predecessor and a follower in the ordered data structure of points. With each point having a predecessor and a follower, thus a conceptual construction of a pair of intersecting line segments at every point forming a vertex is possible.

In contrast however, various other embodiments of the present invention operate on open ended GIS data sets, wherein physical features represented by GIS data sets have at least one starting and one or more ending points. For example, “polyline” shape type data sets as described by the ERSI shapefile format can describe closed loop areas or open ended sets of line segments. A polyline is an ordered set of vertices that consists of one or more parts. A part is a connected sequence of two or more points. Parts may or may not be connected to one another. Embodiments of the present invention operate on polyline GIS data structures to interactively extract (or extract in batch mode), useful measurements and other useful information from vertices data sets. If extracting length information for open ended data sets, then the starting and ending points of the physical feature are defined as measurement vertices by various embodiments of the present invention.

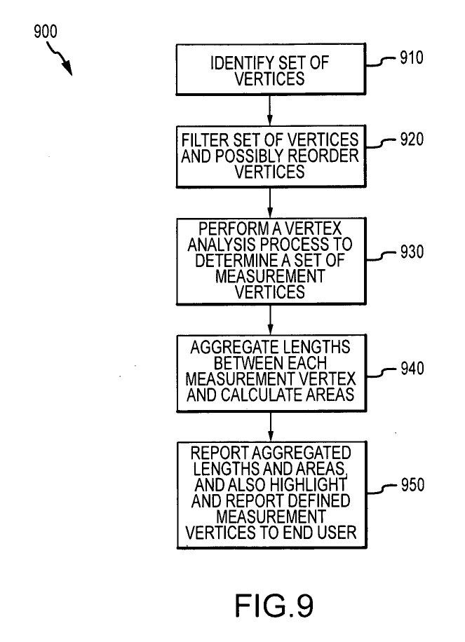

Turning to FIG. 9, a flow diagram 900 represents a method according to embodiments of the present invention. At block 910, a set of vertices are identified. According to one embodiment, the set of vertices may be identified as a result of selection of a physical feature of interest within a GIS data structure and/or other mapping or geographical data by an end user of a GIS application.

In some instances, at block 920, a filtering algorithm can screen for and weed out corrupted data points and potentially problematic data outliers. Filtering is not always done, and is not necessary for all embodiments of the present invention, but some embodiments can perform this analysis. Also, performed some of the times, and may be done in addition to or instead of filtering (block 920), other checking and correcting, i.e. reordering, of data points can be performed by some embodiments of the present invention, and is also illustrated by block 920. Again, checking and correcting ordering, like filtering, are not necessary steps for all embodiments of the present invention, but at times these steps are performed by some instances of various embodiments of the present invention.

In various embodiments of the present invention, a check may be performed to determine if the set of vertices being operated on define a closed loop area, or in the alternative, represent an open ended physical feature having at least one starting vertex and one or more ending vertices.

Then, at block 930, by knowing if the set of vertices representing the physical feature of interest and under investigation is closed loop verses open ended, some embodiments of the present invention will then proceed to programmatically identify a subset of the initially identified (possibly filtered and/or reordered) set of vertices as measurement vertices. According to one embodiment, an appropriate one of several various self contained schemes and algorithms for performing a vertex analysis process is selected and then utilized to determine the measurement vertices from the identified set of vertices. Various different methods, approaches, and algorithms for performing vertex analysis processing exist as will be described further below.

At block 940, after having determined a subset of the identified (possibly, filtered and reordered initial set of identified vertices) as measurement vertices or during the vertex analysis process, the lengths of each segment between measurement vertices is aggregated and the area within the selected polygon or polyline is calculated.

At block 950, results are reported. In one embodiment, one or more of the following are displayed to the user: the aggregated measured lengths between measurement vertices; the calculated areas; and/or the calculated perimeters. In some embodiments, the programmatically identified and/or user defined measurement vertices are also depicted in a manner so as to indicate which of the displayed vertices are currently being used as measurement vertices.

According to one embodiment, when a user has selected to extract information related to a closed loop physical feature of a GIS data set, the vertex analysis process of block 930 defines the subset of measurement vertices from the set of all vertices (or set of all points) associated with the physical feature by: 1) determining a value for an acute or obtuse angle, θ, for every point (or vertex) associated with the physical feature, for all points wherein the two line segments created with each point's predecessor and successor points are not collinear; 2) determining a value for the length of every line segment created between two successive points; and 3) marking the points as measurement vertices if an acute or obtuse angle formed at the point has a value below a predefined or configurable threshold, and if both line segments intersecting the point are above a predetermined or configurable length. In an alternate embodiment, as before, along with the acute or obtuse angle being below a predetermined or configurable threshold limit, for a point to be defined as a measurement vertex, only one of the two line segments may be above the predefined or configurable length threshold.

In another alternate embodiment, measurement vertices are determined by a vertex analysis process comprising: 1) determining a value for an acute or obtuse angle, θ, for every point (or vertex) associated with the physical feature of interest, for all points wherein the two line segments created with each point's predecessor and successor points are not collinear; 2) selecting the point with smallest acute or obtuse angle as a first measurement vertex (if multiple points share the value for the smallest acute or obtuse angle, then the point having the longest line segments associated with it, and intersecting it, is selected, and if still multiple points are tied, one of the contenders is simply selected as a starting point); 3) after a first measurement vertex is selected, then traversing the perimeter of the physical feature in one direction going point-to-point and aggregating the lengths of the line segments until the aggregated length has exceeded a predetermined minimum value, and then selecting the next point in the sequence having an acute or obtuse angle, θ, below a second predetermined threshold value as the second measurement vertex; and 4) repeating step 3) as many times as necessary to find all other potential additional measurement vertices until the periphery of the physical feature of interest has been traversed entirely in one direction.

In yet still further embodiments of the present invention, the user selects a starting point (or starting measurement vertex), or selects multiple measurement vertices to be included, and steps 3) and 4) in the above example of a vertex analysis process are completed as articulated above when traversing the entire periphery of the selected physical feature of interest to programmatically identify the other measurement vertices according to the predetermined length minimum value and an acute or obtuse angle threshold limit. Examples of physical features within GIS data sets analyzed in this fashion include land parcels of interest selected by a user and requested to have area and/or periphery measurements calculated from the source GIS data.

Also, various other embodiments of the present invention using various different algorithms for identifying measurement vertices, and some of these embodiments also allow for users to select and specify additionally one or more of the measurement vertices. Furthermore and similarly, in another alternate embodiment, a user may specify and define only a single starting measurement vertex for the algorithm to begin, and then to programmatically determine all of the other measurement vertices.

Furthermore, other types of physical features, and those defined by open ended data types can be analyzed in a similar fashion as the above examples of various embodiments have articulated, with the only difference being that, the starting and ending points of open ended data sets are included as measurement vertices, and these points can also serve as starting points for accumulating (or aggregating) the length values to meet predetermined minimums before additional measurement vertices are programmatically determined.

Also, and in other alternative embodiments, and has already been discussed in relationship to FIG. 7, only the measurement minimum value alone may be used, or in some cases only the predetermined and specified angle threshold limit alone used to programmatically identify and determine measurement vertices.

Additional further embodiments also allow for the user to select one or more points to be excluded from being identified as measurement vertices. Exclusion of one or more points from being measurement vertices by various embodiments may be done either before or after other measurement vertices have been programmatically identified.

Furthermore, for some other embodiments, as the periphery of a physical feature is traversed, the values of the angles, θ, are accumulated (or aggregated) until a predetermined threshold limit has been found for determining measurement vertices. This is done similarly to methods of some embodiments of the present invention wherein line segment lengths are accumulated for determining measurement vertices, as has been mentioned above.

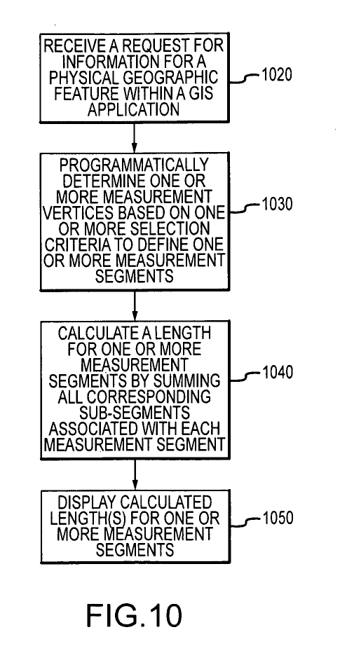

Turning now to FIG. 10, a flow diagram illustrates a method of operation for an embodiment of the present invention. At block 1020, a request is received for information regarding a physical geographic feature displayed within a GIS application. In one embodiment, once a GIS data set is loaded, and is being operated on by a GIS application, a user (or other automatic flow) may first select a geographic feature to be analyzed, and then sometimes later may also make a request for the analysis to programmatically determine the one or more measurement vertices associated with the selected geographic feature. For various embodiments, the measurement vertices selection criteria are defined as one or more threshold limits for: angles, aggregated angles, line segment lengths, and/or aggregated line segment lengths, and these selection criteria threshold limit values may be defined, loaded, and set up within the computer application prior to a request or other indication for the analysis to progress. In yet some further alternate embodiments of the present invention, a geographic feature can be created and is selected for analysis by combining multiple other individual physical features that can each be individually selected through a process, and then are combined for the analysis into one feature by the GIS application.

At block 1030, appropriate vertex analysis processing for the physical geographic feature at issue is selected and performed to programmatically determine one or more measurement vertices based on one or more selection criteria. In one embodiment, the vertex analysis processing determine all measurement vertices and thereby divides the perimeter (or boundary) of the requested physical feature (or combined physical features) into one or more measurement segments based on various predefined selection criteria.

After the measurement vertices are determined, at block 1040, a length is calculated for each measurement segment by summing (or aggregating) the sub-segments that comprise each measurement segment. In some embodiments, areas and other properties of the physical features under investigation are calculated as well.

At block 1050, the calculated values of lengths, areas, or otherwise, are displayed to the user.

The GIS physical feature of interest for many (but not all) applications of embodiments of the present invention are land parcels wherein real estate sellers, buyers, developers, and others whom are interested in one or more parcels', individually or combined, boundaries, perimeters, and areas information. When determining the measurement vertices, similar to as mentioned before, embodiments along the lines of FIG. 10, and other embodiments also, allow for selection (or specification) of one or more data points to be used as a measurement vertices, and a selected point can also serve, in some embodiments, as a starting point for the determination programmatically of all the other measurement vertices. Likewise, through the user, or via another process, one or more points of the GIS data set associated with the physical feature(s) requested and of interest can be explicitly or implicitly excluded from being member(s) of the identified set of measurement vertices. Also as indicated by FIG. 10 in block 1050, for some embodiments, a GIS application may calculate and/or display the length of only a single measurement segment having a sub-segment which has been selected by an end user.

For some embodiments, the GIS data sets comprise vector data files wherein each physical feature is represented as a vector data file, and wherein a vector data file is merely a list of vertices.

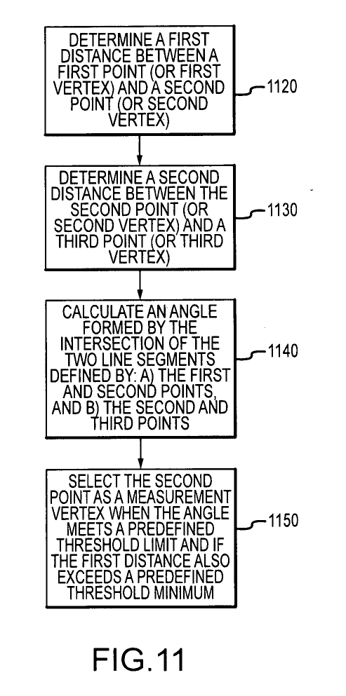

Turning now to FIG. 11, a flow diagram illustrates a method of operation for an embodiment of the present invention. FIG. 11 represents just one embodiment from many various different approaches for identifying one or more measurement vertices. FIG. 11 represents an example of potential vertex analysis processing that may be performed in block 930 of FIG. 9 and/or block 1030 of FIG. 10, and elsewhere. At block 1120, a first distance is determined between a first point and a second point. In one embodiment, the points depicting a physical feature within a GIS application have an implied and often explicit order, such that each of the pairs of points (or vertices) may be considered to have a determinable distance between them. In such embodiments, block 1120 is performed by making a determination of a distance between two consecutive points.

At block 1130, another distance is determined between the latter of the two consecutive points and the next point in the sequence. The distance calculated in block 1120 and the distance calculated in block 1130 each represent line segments which intersect at a common point.

At block 1140, the angle formed by the intersection of these aforementioned line segments is calculated. If the two line segments are collinear, then the angle formed is 180 degrees or π radians. If the two line segments are not collinear, then two angles are formed, one acute or obtuse angle, and one reflex angle.

At block 1150, the second point of the series of consecutive points is selected as a measurement vertex when the angle meets a predefined threshold limit and if the first distance also exceeds a predefined threshold minimum. Generally, most embodiments will record and calculate a value for the acute or obtuse angle, wherein this angle is to be compared against a minimum threshold value, and the point selected as a measurement vertex whenever the acute or obtuse angle is below the threshold limit, and so long as all other selection criteria or criterion are met as well. However, for some embodiments, recording and storing the reflex angle value, and comparing this reflex angle value to be above a threshold limit is just as valuable, and is just as useful, as using the acute or obtuse angle as described above and elsewhere.

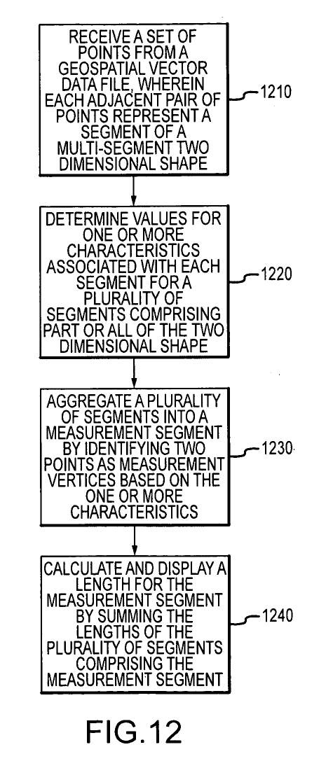

Turning now to FIG. 12, a flow diagram illustrates a method of operation for multiple embodiments and/or instances of the present invention. FIG. 12 at the highest level can represent one or more of the embodiments (or instances) of the present invention) through various interpretations and/or more detailed information related to each of the blocks.

At block 1210, a set of points is received representing a two dimensional shape, whereas other approaches are equally valid using any one of a variety of three dimensional coordinate systems for representing each point. In one embodiment, the points are in an ordered sequence such that adjacent pairs of points can be identified.

At block 1220 values for at least one of the “characteristics” associated with each line segment defined by adjacent points is determined. For example, these “characteristics” can be a length of the line segment, and/or values for either the reflex angle and/or the acute or obtuse angle formed at one end, the other end, or both ends of the line segment. Furthermore, a host of other “characteristics” associated with each segment can be identified according to various different embodiments of the present invention.

At block 1230, based on the one or more of the characteristics of interest, two of the points from the set of points are identified as measurement vertices. Thus, a measurement segment is defined as the aggregation of all the segments between the two identified measurement vertices.

At block 1240 a length for the identified measurement segment is calculated and displayed. For many embodiments, of the current invention, the flow of FIG. 12 is repeated until the entire set of points from the geospatial vector data file has been examined and an appropriate set of measurement segments defined by an appropriate set of measurement vertices are defined.

However and in contrast, and for some embodiments, and for some sets of points, only a pair of measurement vertices are determined when examining an entire set of points representing a physical feature under examination as part of a GIS data set. For example, if a parcel is shaped as one half of a circle, then only two measurement vertices may be identified by some embodiments of the present invention. For such an example, the two measurement segments for some embodiments of the present invention are: a) the straight line representing the diameter of the circle and illustrating part of the periphery of the parcel, and b) the arc representing the one half of the circle and illustrating the rest of the parcel periphery.

Furthermore, various embodiments of the present invention will differ in how measurement vertices are assigned and used. For example, if a circular parcel is selected to be operated on and measured by various embodiments of the present invention, then depending upon which embodiment of the present invention, and depending on all identified segment characteristics, i.e. and depending on the measurement vertices selection criteria, and how threshold values are defined, zero, one, two, or more than two measurement vertices and measurement segments can be identified.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving a request for information regarding a shape displayed within a geographic information system (GIS) application, the shape representing a geographic feature;
programmatically identifying one or more measurement segments by selecting a plurality of measurement vertices from a set of points associated with the shape based on one or more predetermined selection criteria, wherein remaining intervening points of the set of points not selected as measurement vertices define one or more sub-segments of the one or more measurement segments;
calculating a length of each of the one or more measurement segments by summing corresponding sub-segments; and
displaying the length of each of the one or more measurement segments.

2. The method of claim 1, wherein the shape corresponds to a parcel boundary and the calculated length represents a portion of a perimeter of the parcel boundary.

3. The method of claim 2, wherein the portion of a perimeter of the parcel boundary includes the perimeter of the parcel boundary in its entirety.

4. The method of claim 1, further comprising receiving an indication regarding a point of the set of points to be used as a starting measurement vertex.

5. The method of claim 1, further comprising receiving an indication regarding a point of the set of points to be excluded from the plurality of measurement vertices.

6. The method of claim 1, further comprising receiving an indication regarding a point of the set of points to be included within the plurality of measurement vertices.

7. The method of claim 1, wherein the request comprises an end user selection of a sub-segment of the shape and wherein said identifying, calculating and displaying is performed only for a measurement segment including the selected sub-segment.

8. The method of claim 1, further comprising reading the set of points from a vector data file.

9. The method of claim 8, wherein the vector data file comprises a shapefile.

10. The method of claim 9, wherein the shapefile comprises a format defined by ERSI™ shapefile format.

11. The method of claim 1, further comprising the geographic information system (GIS) application operates on MapInfo Interchange Format (.mif) files.

12. The method of claim 1, further comprising the geographic information system (GIS) application operates on Keyhole Markup Formats (.kml) and (.kmz) files.

13. The method of claim 1, further comprising:
determining a first distance between a first point and a second point of the set of points determining a second distance between the second point and a third point of the set of points;
calculating an angle formed by a first sub-segment bounded by the first point and the second point and a second sub-segment bounded by the second point and the third point; and
selecting the second point as one of the plurality of measurement vertices if the angle meets a predefined angle threshold and the first distance meets a predefined distance threshold.

14. A method comprising:
retrieving a set of points from a geospatial vector data file, each adjacent pair of points of the set of points representing a segment of a multi-segment, two-dimensional shape;
programmatically determining one or more characteristics associated with a plurality of segments of the multi-segment, two-dimensional shape;
programmatically aggregating the plurality of segments into a measurement segment by identifying two points of the set of points to be used as measurement vertices based on the one or more characteristics;
calculating and displaying a length of the measurement segment by summing lengths associated with each of the plurality of segments.

15. A method comprising:
a step for receiving a request for information regarding a shape displayed within a geographic information system (GIS) application, the shape representing a geographic feature;
a step for programmatically identifying one or more measurement segments by selecting a plurality of measurement vertices from a set of points associated with the shape based on one or more predetermined selection criteria, wherein remaining intervening points of the set of points not selected as measurement vertices define one or more sub-segments of the one or more measurement segments;
a step for calculating a length of each of the one or more measurement segments based on corresponding sub-segments; and
a step for displaying the length of each of the one or more measurement segments.

16. A program storage device readable by one or more processors, tangibly embodying a program of instructions executable by the one or more processors to perform method steps for measuring characteristics of a shape, representing a geographic feature, displayed within a geographic information system (GIS) application, said method steps comprising:
programmatically identifying one or more measurement segments by performing a vertex analysis process to select a plurality of measurement vertices from a set of points associated with the shape based on one or more predetermined selection criteria, wherein remaining intervening points of the set of points not selected as measurement vertices define one or more sub-segments of the one or more measurement segments;
calculating a length of each of the one or more measurement segments by summing corresponding sub-segments; and
displaying the length of each of the one or more measurement segments.
